(19) United States
(12) Patent Application Publication
(10) Pub. No.: US 2006/0074783 A1
(43) Pub. Date: Apr. 6, 2006

(54) Real-time pin disbursement system

(76) Inventors: Rajat Agarwal, Secaucus, NJ (US); Asheem Aggarwal, New York, NY (US); Younes Oughla, West New York, NJ (US); Pankul Verma, Jersey City, NJ (US)

Correspondence Address: WHITE & CASE LLP;PATENT DEPARTMENT, 1155 AVENUE OF THE AMERICAS, NEW YORK, NY, 10036, US

(21) Appl. No.: 10/949,047

(22) Filed: Sep. 24, 2004

(51) Int. Cl. G06Q 40/00

(52) U.S. Cl. 705/35

(57) ABSTRACT

An automated system and method of purchasing prepaid and other services against a deposit or a credit threshold. A server provisions requests for electronic PINs. This provisioning server maintains a record for each retail merchant, distributor, or third party processor. Depending on their credit worthiness, the control server either establishes a credit threshold retail merchant, distributor or third party processor or requires a cash deposit. A retail merchant or distributor or a third party processor may obtain an electronic PIN from the provisioning server in real-time or in batches against their credit threshold or deposit.

### BACKGROUND OF THE INVENTION

The invention pertains to the provisioning of prepaid and other services including systems and methods for automated delivery of such services against a credit threshold or a deposit.

Conventionally, provisioning prepaid services involves a consumer visiting a retail sale location typically owned by or affiliated with the provider or carrier of the desired service. Once the consumer selects the desired service, the retailer either provides an access code, often in the form of a personal identification number (PIN) from a locally maintained inventory of PINs purchased from the carriers/providers or from a third party distributor, or contacts the carrier/provider to obtain a PIN for the requested service.

To provide a PIN from a local inventory, a retail merchant typically has to purchase PINs in bulk from carriers, providers, and/or wholesalers and load these PINs in batches into their inventory. The process of buying and loading PINs is time-consuming, manual, and repetitive. Automation of this process by retail merchants is largely ruled out as there are at least fifteen (15) carriers/providers of telephony services, not to mention providers of other kinds of services, and each one has its own, often proprietary system for supplying PINs. Therefore, providers of electronic PINS have to dedicate manpower to uploading PINs on an ongoing basis, thereby adding to the cost of doing business.

Additionally, merchants must predict the demand for specific services and stock up on PINs for those services to ensure that they have the PINs available when a customer requests them. This requires a merchant to invest significant amounts into maintaining a local inventory of PINs from various carriers/providers.

Alternatively, merchants provide PINs by requesting them directly from the carrier/provider at the time of the customer's request. This arrangement requires the merchant to have a relationship with each individual carrier or service provider.

### SUMMARY OF THE INVENTION

The present invention is directed to a system and method for provisioning prepaid and other services that can reduce the time, cost and manpower, and mitigates or eliminates credit risks.

Real-time PIN delivery eliminates the need for distributors and merchants to place advance orders for PINs, to forecast demand, and to send payments to various suppliers. Also, distributors and merchants do not have to receive batch files, and load such batch files into their databases. Moreover, aspects of the present invention allows real-time PIN providers, distributors and merchants to mitigate credit risk on the sale of electronic products and services by providing PINs against a preset credit threshold or a deposit.

Aspects of the present invention allow a PIN distributor to establish supply lines with carriers, providers and wholesalers, and to purchases PINs in bulk. Because of the volume of purchases, the PIN distributor is able to get the best discounts on products, as well as buy and load PINs at a lower cost.

Aspects of the present invention provide an automated method of buying electronic PINs for prepaid services against a deposit or a credit threshold. Another aspect of the invention is providing a streamlined, automated process for provisioning various types of prepaid services by way of real-time PIN disbursement. Yet another aspect of the present invention is to minimize the financial risk involved in provisioning real-time requests for prepaid services.

Standard point-of-sale PIN dispensing businesses require the carrier, provider or wholesaler to extend credit to the retail merchant. In an embodiment of the present invention, the merchant or distributor either has a predetermined credit threshold or a deposit against which its purchases are charged, thus mitigating or eliminating the credit risk to the carrier/provider or wholesaler.

Distributors or retail merchants using the present invention can have access to a wide array of prepaid wireless products. Thus, they, do not need to contract directly with individual carriers, providers, or wholesalers of prepaid services. By simply placing a deposit, they can have access to inventory from a wide variety of carriers or providers, without the headache of placing individual orders.

A retail merchant who sells 100,000 PINs per month from fifteen (15) different carriers/providers and places four (4) orders a month from each carrier would have to place sixty (60) separate orders per month. Also, certain product items do not have a high demand. Since there is a carrying cost to all items, and a higher investment in higher value PINs, many merchants/distributors do not carry slow-moving items or higher value items. Aspects of the present invention may provide merchants and distributors with access to more PINs without additional investment in inventory carrying costs. This also means that the merchant or distributor can buy what is needed rather than investing in inventory that may or may not sell.

Since the central provisioning server provides inventory to many different merchants, the PIN inventory of the provisioning server would be much better stocked than the inventory bank of any one merchant or distributor. As such merchants/distributors can run a lower risk of running out of inventory. Aspects of the present invention may also streamline the process of buying, paying for, and loading PINS, thereby reducing operational costs for merchants and distributors and making the sale process easier.

### BRIEF DESCRIPTION OF THE DRAWINGS

FIG. 1 is a flowchart representation of the PIN dispensing system of a preferred embodiment of the present invention.

FIG. 2 is a flow chart representing preferred steps taken in provisioning a request for an electronic PIN.

FIG. 3 presents a chart of preferred sample errors that may be returned in response to a request for a PIN.

FIGS. 4a and 4b illustrate preferred screen images reporting user record balances and transaction history according to the invention.

### DETAILED DESCRIPTION OF THE PREFERRED EMBODIMENTS

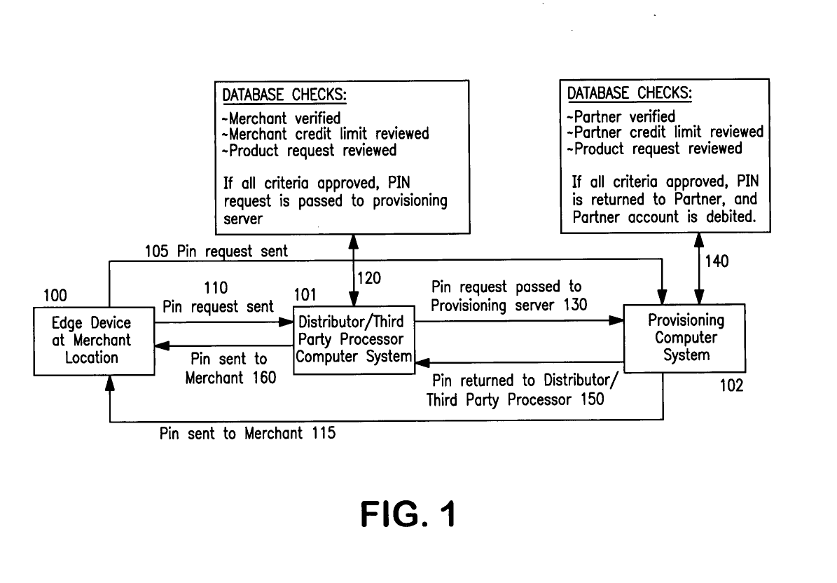

In a preferred embodiment, of the present invention, as illustrated in FIG. 1, each user (fore example retail merchant, distributor, wholesaler, third party processor, other partner, etc.) who desires to access the provisioning system 102 has a record in a database accessible to the provisioning server. A user ID is preferably generated for each user record.

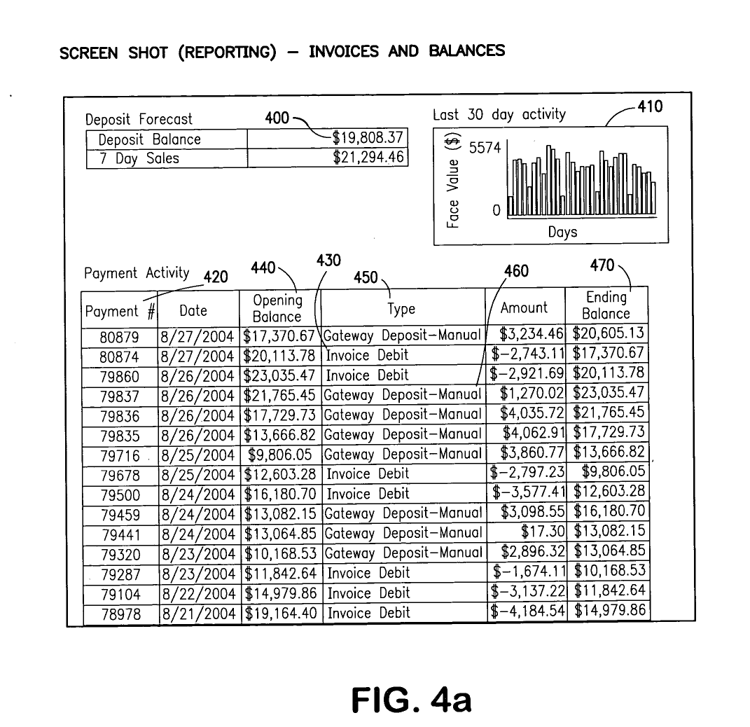

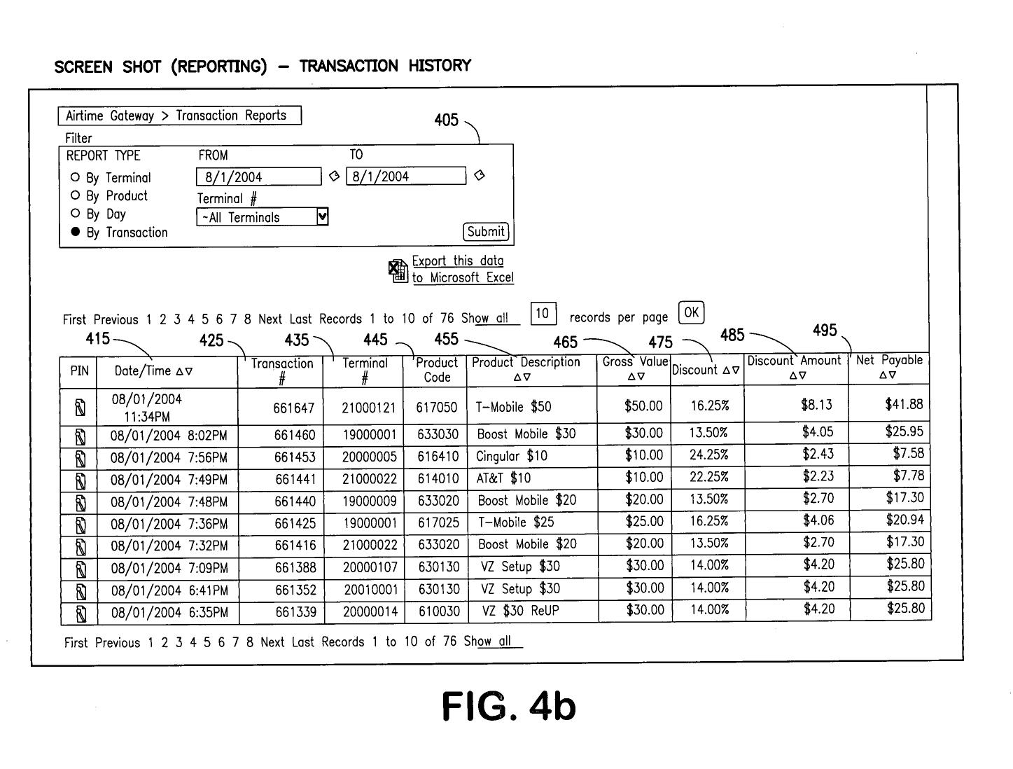

For each user, a credit threshold is preferably established for the user to obtain PINs against via the present invention. Alternatively, a cash deposit 400 may be required against which the user can purchase PINs. The system may preferably track the available balance (470) for the user's purchases. As illustrated in FIG. 4a, this balance may be depleted by purchases (430) and replenished by payment of invoices (in the case of credit lines) or by additional deposits 460.

In a preferred embodiment, the user ID may be associated with a terminal identifier 435 that corresponds to the way(s) in which the user may access the provisioning server 102. Terminal identifier 435 may correlate to a point-of-sale terminal, an Internet access point, a facsimile machine, a telephone line, or other similar mode of access.

Also, each user is preferably issued a unique authentication key to allow it to request PINs from provisioning server 102. In some embodiments of this invention, additional modes of authentication may be required. For example, a given user record may require a passkey for each transaction or may have an IP (internet protocol) address restriction associated with it. These additional authentication measures may be implemented on a case-by-case basis at the request of the user.

Each user may also receive a list of item numbers (SKUs) corresponding to specific services, carriers, providers, and transaction amounts available from the provisioning server.

In one embodiment of the invention, a retail merchant has a terminal 100 that has access to a central provisioning server 102 on which the retail merchant has a record. The retail merchant's record is assigned a given credit threshold related to the retail merchant's creditworthiness. The retail merchant is able to send requests (105) to the provisioning server and receive PINs (115) against the established credit threshold. Alternatively, the retail merchant may provide cash deposit against which it can obtain PINs.

In another embodiment of the present invention, a retail merchant contracts with a distributor. The distributor preferably has a computer system 101 that is connected to the central provisioning server. The distributor (not the retail merchant) preferably has a record on the provisioning server and either has a credit threshold or a deposit to obtain PINs from the provisioning server. The retail merchant sends requests 110 for PINs to the distributor's computer system 101. All purchases of the retail merchant are deemed purchases of the distributor and are deducted from the distributor's user record.

In another embodiment of the present invention, a retail merchant contracts with a distributor connected to a third party processor. The third party processor (who may also be a distributor) has a computer system connected to the central provisioning server. All transactions by the retail merchant are channeled through the third party processor and charged against the credit threshold or deposit of the distributor.

In yet another embodiment of the present invention, PINS can also be pulled in batches (near real-time) rather than being pulled real-time (one at a time).

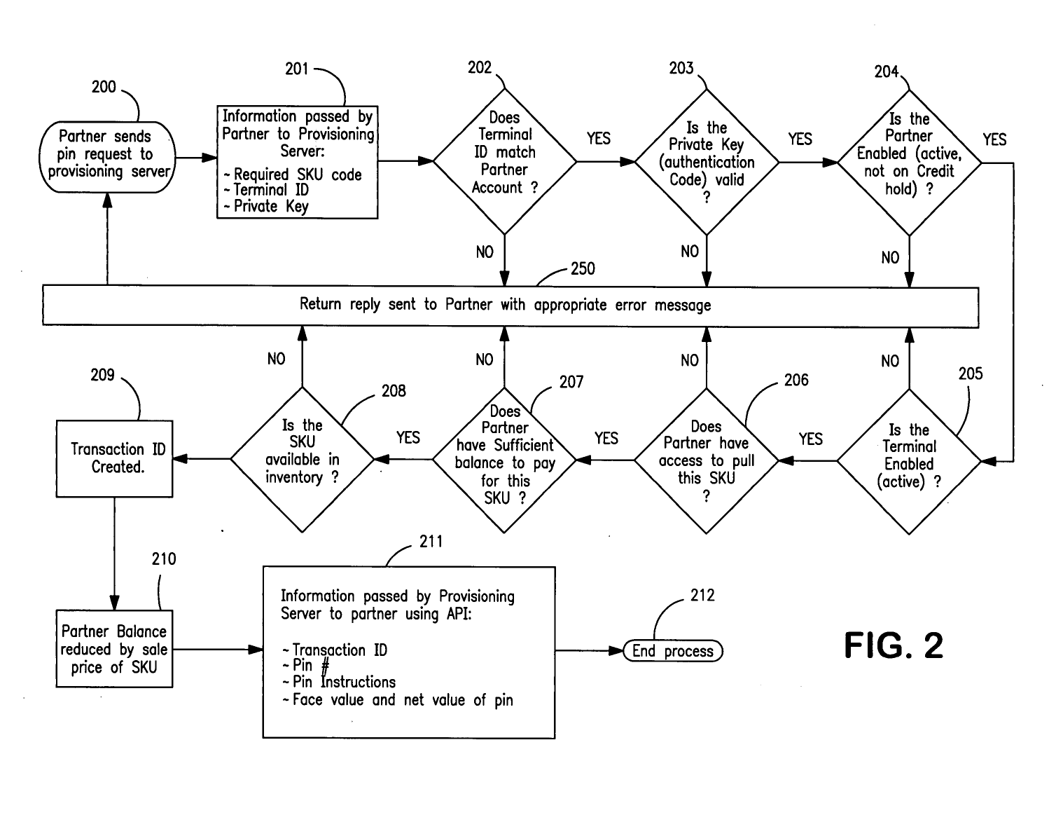

FIG. 2 illustrates the process of obtaining a PIN in a preferred embodiment of this invention. As shown in step 200 of FIG. 2, a user may submit a request for a PIN by passing the request to provisioning server 102 using an application programming interface (API). The request includes at least the item number (SKU), the terminal ID from which the request is being made, and the authentication key associated with the user record—201.

Provisioning server 102 preferably maintains or has access to a database of all users (retail merchants, distributors, third party processors, or other partners) who have a user ID allowing them access to the provisioning server. In the preferred embodiment, provisioning server 102 looks up in the user record associated with the terminal ID passed along with each request in this database. The terminal ID is verified as matching a user record in step 202. The authentication key provided is preferably checked to ensure that it matches the authentication parameters associated with the user record in question in step 203.

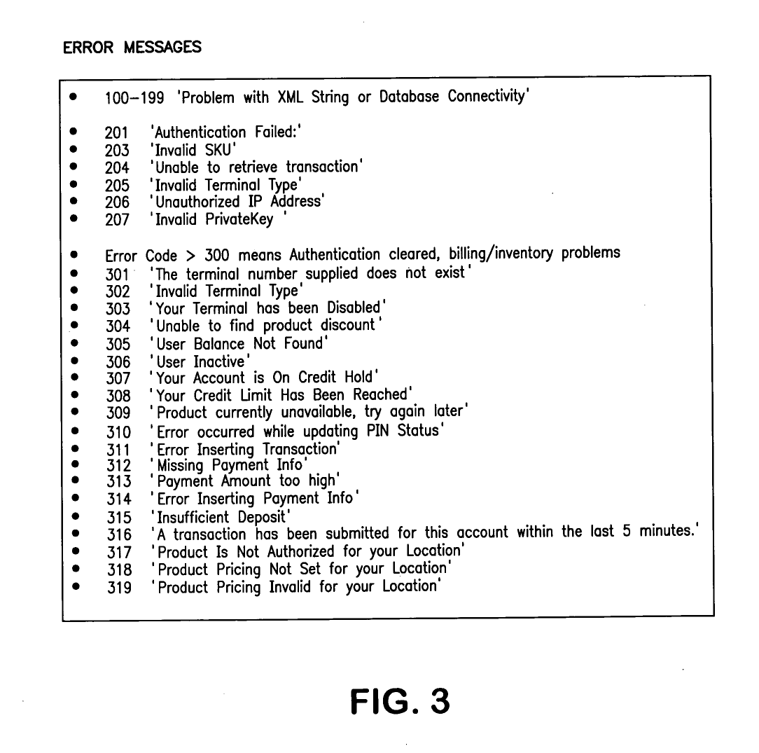

In a preferred embodiment of the present invention, user records may be either enabled—i.e., allowed to do access the provisioning server, or disabled—i.e., not allowed to do access the provisioning server. A table indicating the status of each user is preferably maintained as part of a database accessible to the provisioning server. In a preferred embodiment, for each request received from a user in step 200, the provisioning server then performs a check of this table in step 204. If the user is enabled, the provisioning server continues to process the request. However, if the user is disabled, an appropriate error message preferably from the table in FIG. 3 is generated and sent back to the user in step 250.

In certain embodiments of the present invention, further security checks may be established to control access to provisioning server 102. For example, in one embodiment of the invention, only requests received from certain IP addresses previously identified as being associated with a particular user record may be processed. The enabled IP addresses may be stored in a database that the provisioning server may query in step 205 whenever it receives a request. This may ensure that requests from unauthorized sources are not processed.

In the preferred embodiment, provisioning server 102 preferably checks whether the user is authorized to receive the requested item number (SKU) 445 in step 207. There are several different types of products that may be provisioned by provisioning server 102. Some examples include, prepaid wireless services, bill payment for various utilities, electronic toll collection, prepaid telecommunication services, lottery products, etc.), and each product may be available in different denominations (e.g., $5, $10, $20, $25, etc.). Thus, item numbers (SKUs) may preferably be stored in a database accessible to provisioning server 102. These item numbers (SKUs) facilitate the retrieval of PINs corresponding to the requested service and transaction amount.

In certain embodiments of the present invention, not all users have access to each item number. For example, certain item numbers (SKUs) could be restricted by the carriers/providers to certain geographical regions, while others could be acquired exclusively for specific users. A table of item numbers authorized for each user may be maintained in a database accessible to the provisioning server. When a request is received from a user, the table is checked to determine whether the user may receive the requested item number (SKU). If the user is authorized to access the requested item number, provisioning system 102 continues to process the request. If not, an appropriate error message is transmitted back to the user.

In the preferred embodiment of this present invention, provisioning server 102 checks whether there is a positive deposit balance in the user record sufficient to cover the price of the requested product. As illustrated in FIG. 4b, in certain embodiments of the present invention, discounts for each item number are stored in a table and used to calculate the price. For example, PRICE={Face Value (−) User Discount}. In step 207, provisioning server 102 checks whether the balance in the user record is sufficient to cover the discounted sales price. If the balance is adequate, provisioning server 102 continues to process the request. Otherwise, an appropriate error message is transmitted to the user.

In the preferred embodiment of the present invention, if the request SKU is available in the inventory in step 208, provisioning system 102 preferably generates a unique transaction ID 425 for the transaction in question in step 209. The record associated with transaction ID 425 may store all the details of the particular transaction, including: the date, time, user name, terminal ID, product code, product name, SKU number, PIN, serial number, and discount applied. In the preferred embodiment, the transaction ID may be passed to the user via the API along with the PIN information in step 211. For example:

| | |
|---|---|
| PIN #: | 3154986273111 |
| Serial #: | 123456789 |
| Transaction #: | 740044 |
| Error Code/Text: | (if applicable) |

An XML example:

<VIAONE>
<PG_GetPIN>
<ErrorCode>0</ErrorCode>
<PIN>17005166736307</PIN>
<Serial>4002034588368</Serial>
<TransactionID>153033</TransactionID>
</PG_GetPIN>
</VIAONE>

If any of the foregoing steps produce an error, an appropriate message is preferably returned to the user. FIG. 3 shows some of the error messages that may be passed back to the user in the preferred embodiment of this invention.

Where the transaction is successful, the transaction amount is deducted from the balance of the user record in step 210.

For example:

| | |
|---|---|
| Starting User Balance: | $5385.00 |
| Product Description: | Cingular $50.00 |
| Gross Value: | $50.00 |
| Discount: | 24.00% |
| Discount Amount: | $12.00 |
| Net Payable: | $38.00 |
| Ending User Balance: | $5347.00 |

Although the invention has been described with respect to preferred embodiments in the figures and the foregoing description, it is not intended to be so limited. Changes, modifications and variations can be made therein which are within the full intended scope of this invention. It is also understood that those skilled in the art, both now and in the future, may make various improvements and enhancements which fall within the scope of the claims that follow. Thus, the scope of the invention should be determined by the appended claims and their legal equivalents and these claims should be construed to maintain the proper protection for the invention first disclosed herein.

What is claimed is:

1. A method for provisioning prepaid services comprising:
receiving a request from a user, said request including at least a service, a terminal identifier, and an authentication;
verifying that said terminal identifier matches a record associated with said user;
determining validity of said authentication;
verifying that said user is enabled to access the provisioning server;
determining whether said user record allows access to said service;
granting said request where said service is available and where the balance of said user record is equal to or greater than a price associated with said service; and
reducing said balance of said user record by an amount related to said price.

2. The method of claim 1, further comprising verifying the request was received from an authorized IP address.

3. The method of claim 1, further comprising determining whether a discount applies to said request, and reducing said price of said service by said discount.

4. The method of claim 1 where said user is a retail merchant.

5. The method of claim 1 where said user is a distributor.

6. The method of claim 1 where said balance of said user record is determined in part by a deposit.

7. The method of claim 1 where said balance of said user record is determined in part by a credit limit associated with said user record.

8. A prepaid services provisioning system comprising:
a database of access codes for various services;
a processing unit communicatively coupled to said database; wherein
said processing unit is configured to receive a request for an access code from a user;
said user having a record;
said user record having a balance equal to or greater than a price associated with said access code;
said database issuing an access code to said user; and
said balance of said user record being reduced by said price.

9. The system of claim 8 where said user is a retail merchant.

10. The system of claim 8 where said user is a distributor.

11. The system of claim 8 where said balance of said user record is determined in part by a deposit.

12. The system of claim 8 where said balance of said user record is determined in part by a credit limit associated with said user record.

13. A prepaid services provisioning system comprising:
means for receiving a request from a user, said request identifying at least a service, a terminal identifier, and an authentication;
means for verifying that said terminal identifier matches a record associated with said user;
means for determining validity of said authentication;
means for verifying that said user is enabled to access the provisioning server;
means for determining whether said user record allows access to said service;
means for granting said request where said service is available and where the balance of said user record is equal to or greater than a price associated with said service; and
means for reducing said balance of said user record by an amount related to said price.

14. The system of claim 13 where said user is a retail merchant.

15. The system of claim 13 where said user is a distributor.

16. The system of claim 13 where said balance of said user record is determined in part by a deposit.

17. The system of claim 13 where said balance of said user record is determined in part by a credit limit associated with said user record.
